(19) United States
(12) Patent Application Publication
(10) Pub. No.: US 2025/0088261 A1
(43) Pub. Date: Mar. 13, 2025

(54) TELECOMMUNICATIONS APPARATUS AND METHODS

(71) Applicant: Sony Group Corporation, Tokyo (JP)

(72) Inventors: Vivek SHARMA, Basingstoke (GB); Yassin Aden AWAD, Basingstoke (GB); Hideji WAKABAYASHI, Basingstoke (GB); Yuxin WEI, Basingstoke (GB)

(73) Assignee: Sony Group Corporation, Tokyo (JP)

(21) Appl. No.: 18/723,871

(22) PCT Filed: Dec. 6, 2022
(86) PCT No.: PCT/EP2022/084639

§ 371 Date: Jun. 25, 2024

(30) Foreign Application Priority Data
Jan. 7, 2022 (EP) 22150620.7

(51) Int. Cl. H04B 7/155

(52) U.S. Cl. CPC H04B 7/15557

(57) ABSTRACT

A system comprising a repeater, a first radio node and a terminal wherein the first radio node is configured to provide a wireless access interface to communicate with the terminal. The first radio node is configured to make a determination that the radio node supports a network-controlled repeater functionality; based on the determination, transmit a first indicator indicating that the radio node supports the network-controlled repeater functionality; and based on the determination, transmit control information for the repeater to configure a network-controlled repeater mode. The repeater is configured to monitor for the first indicator; when the first indicator is detected: receive first control information from the first radio node; and configure the repeater to operate in a network-controlled repeater mode for the first radio node and based on the first control information; and when the first indicator is not detected, configure the repeater to operate in an autonomous repeater mode.

### BACKGROUND

### Field

The present disclosure relates to communications devices, infrastructure equipment and methods for the transmission of data by a communications device and an infrastructure equipment in a wireless communications network.

The present application claims the Paris Convention priority from European patent application number EP22150620.7, filed on 7 Jan. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Latest generation mobile telecommunication systems are able to support a wider range of services than simple voice and messaging services offered by earlier generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example, it is expected future wireless communications networks will be expected to efficiently support communications with devices including reduced complexity devices, machine type communications devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of a desire to support new types of devices with a variety of applications there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

As is well understood, various wireless telecommunications networks, such as LTE-based networks and NR-based networks, support different Radio Resource Control (RRC) modes for terminal devices, typically including: (i) RRC idle mode (RRC_IDLE); and (ii) RRC connected mode (RRC_CONNECTED). When a terminal device transmits data, RRC connected mode is generally used. The RRC idle mode, on the other hand, is for terminal devices which are registered to the network (EMM-REGISTERED), but not currently in active communication (ECM-IDLE).

In order for a core network to maintain knowledge of the location of terminal devices in idle mode, the wireless networks referred to above generally utilise tracking areas or registration areas defined by operators in order to track terminal devices to a particular geographical region consisting of a number of cells. A terminal device may roam within this tracking/registration area without transmitting update messages to the core network and as such the core network may be aware of the tracking area or registration area in which a terminal device in idle mode is located.

However, tracking areas and registration areas generally cover a large geographical area and therefore do not provide the core network with a precise indication of the location of an idle mode terminal device. Without more precise knowledge of an idle mode terminal device's location, it can be difficult or even impossible to implement certain network features. Furthermore, tracking and registration areas are generally defined when the wireless telecommunications networks are deployed and as such it is an extensive and difficult job for network operators to adjust tracking and registration areas in existing networks.

The present inventors have identified new techniques for addressing some of these challenges with wireless communications networks.

### SUMMARY

Aspects of the invention are defined in the appended claims, where due account shall be taken of any element which is equivalent to an element specified in the claims.

According to a first aspect, there are provided methods, apparatuses and circuitry for a repeater, where the repeater is configured to monitor for a first indicator, from the first radio node, that the first radio node supports a network-controlled repeater functionality; when the first indicator is detected: receive first control information from the first radio node; and configure the repeater to operate in a network-controlled repeater mode for the first radio node and based on the first control information; and, when the first indicator is not detected, configure the repeater to operate in an autonomous repeater mode.

According to a second aspect, there are provided methods, apparatuses and circuitry for a radio node where the radio node is configured to make a determination that the radio node supports a network-controlled repeater functionality; based on the determination, transmit a first indicator indicating that the radio node supports the network-controlled repeater functionality; and based on the determination, transmit control information for the repeater to configure a network-controlled repeater mode.

According to a third aspect, there are provided methods and systems for use in a for use in a telecommunications network, the system comprising a repeater, a first radio node and a terminal wherein the first radio node is configured to provide a wireless access interface to communicate with the terminal, wherein the first radio node is configured in accordance with the second aspect and wherein the repeater is configured in accordance with the first aspect.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured in accordance with example embodiments;

FIG. 4 shows a flow chart of a method for operating a repeater;

FIG. 5 shows a flow chart of a method for operating a radio node;

FIG. 6 illustrates an example of interference in a system with a repeater;

FIG. 7 illustrates another example of interference in a system with a repeater; and

FIG. 8 illustrates a further example of interference in a system with a repeater.

### DETAILED DESCRIPTION OF THE EMBODIMENTS

### Long Term Evolution Advanced Radio Access Technology (4G)

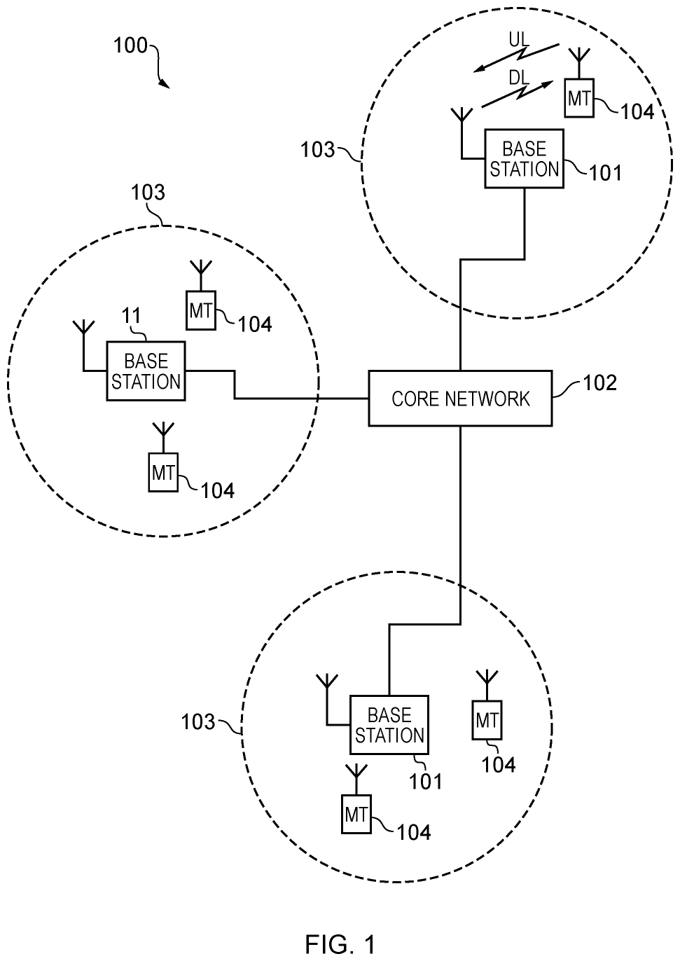

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well known and defined in the relevant standards administered by the 3GPP (®) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard, different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity, certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

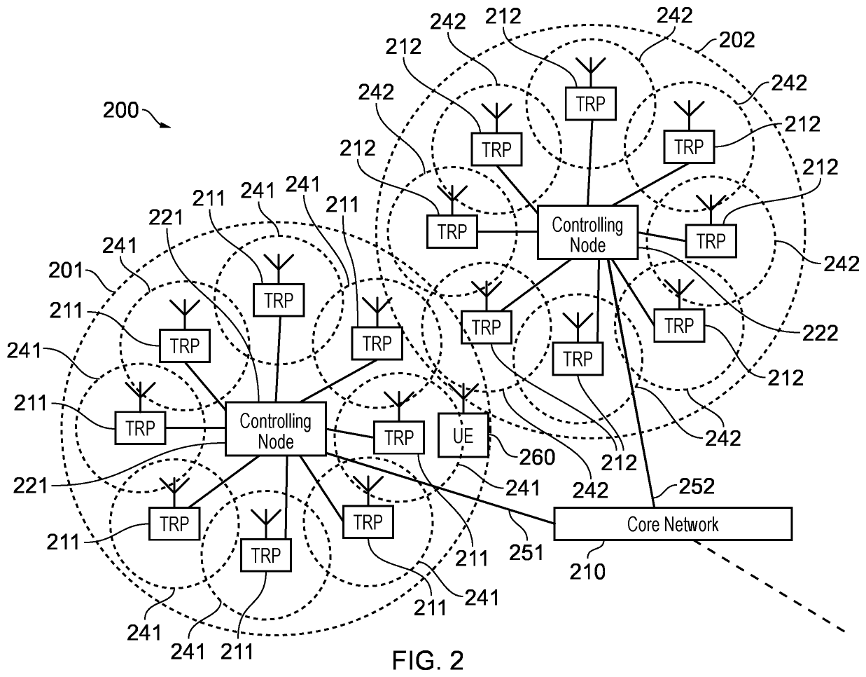

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus, example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type infrastructure equipment 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

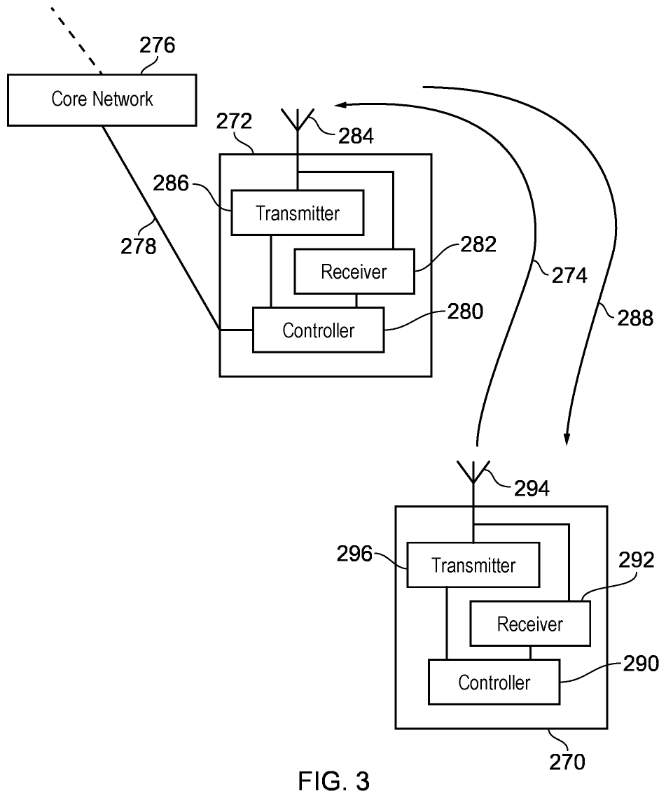

A more detailed illustration of a UE/communications device 270 (which may correspond to a communications device such as the communications device 260 of FIG. 2 or the communications device 104 of FIG. 1) and an example network infrastructure equipment 272, which may be thought of as a base station 101 or a combination of a controlling node 221 and TRP 211, is presented in FIG. 3. As shown in FIG. 3, the UE 270 is shown to transmit uplink data to the infrastructure equipment 272 via uplink resources of a wireless access interface as illustrated generally by an arrow 274 from the UE 270 to the infrastructure equipment 272. The UE 270 may similarly be configured to receive downlink data transmitted by the infrastructure equipment 272 via downlink resources as indicated by an arrow 288 from the infrastructure equipment 272 to the UE 270. As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Repeaters

Some of the systems still currently in development (e.g. NR) do not define a repeater function, while other systems can include repeaters, for example, repeater are defined in LTE systems. A repeater or RF repeater may be viewed as an element which receives a radio signal from a radio node (e.g. a base station or gNB, a relay, etc.), amplifies the signal and retransmits the signal without providing connectivity to the UE through an interface, such as a UE-base station interface (e.g. a Uu interface) or a UE-UE interface (e.g. a PC5 interface). As the repeater does not provide an interface to the terminal or UE and is operating as a transparent radio amplifier, amplifiers are sometimes referred to as radio frequency amplifiers, radio amplifiers or RF amplifiers. In the interest of conciseness, such amplifiers will be referred to “amplifiers”.

Some repeaters may also be referred to as smart repeaters or network-controlled repeaters when the repeaters are able, beyond the radio amplification function, to provide additional functions, such as processing control information from a base station and configuring the radio parameters for its transmission of amplified radio signals based on the received control information. For example and as discussed below, some network-controlled repeaters may be configured to receive and process side control information from the network and for example take into account configurations such as semi-static and/or dynamic downlink/uplink configuration, adaptive transmitter/receiver spatial beamforming, ON-OFF status, etc. While a smart repeater may mimic some L1 functions of a base station (e.g. gNB), it will require an interface with the base station to receive the side control information. The interface may be a Uu interface for example. The side control information may include information regarding radio resources to use, uplink/downlink information (in particular in TDD mode), beamforming information, operation mode, etc. Such smart or network-controlled repeaters differ from non-network-controlled repeaters, also referred to herein as autonomous repeaters, in that autonomous repeaters operate without receiving a configuration parameter from the network (e.g. from a base station or other type of radio node) which is adapted to the cell or radio node whose signals are to be repeated. In other words, an autonomous repeater uses a configuration which is independent of, or de-correlated from, the radio node whose signals it is repeated. Amplifiers discussed above are examples of autonomous repeaters.

In the field of repeaters, the skilled person will be familiar with the concepts of active repeaters and passive repeaters. A passive repeater can be seen as a repeater which amplifies the radio signal and transmits the amplified signal without decoding the received signal or without any processing of the received signal besides the amplification. On the other hand, an active repeater can decode the radio signals and re-generate a new (and amplified) radio signal. Smart repeaters or network-controlled repeaters can be seen as a type of active repeaters which are configured through side control information from a base station. Autonomous repeaters tend to be mostly passive repeaters although some autonomous repeaters may be active repeaters, if for example they can operate as active repeaters using a pre-configuration and/or a configuration that can be used for a plurality or all of the radio nodes it can repeat.

It is expected that repeaters-and in particular smart or network-controlled repeaters-will be used predominantly in Time Division Duplex (TDD) deployments, such as in a frequency range often referred to as Frequency Range 2 (FR2). 3GPP document RP-212703 [2] and RP-213700 [3] may be of interest to the reader. RP-212703 [2] discusses the following:
“Coverage is a fundamental aspect of cellular network deployments. Mobile operators rely on different types of network nodes to offer blanket coverage in their deployments. Deployment of regular full-stack cells is one option but it may not be always possible (e.g., no availability of backhaul) or economically viable.
As a result, new types of network nodes have been considered to increase mobile operators' flexibility for their network deployments. For example, Integrated Access and Backhaul (IAB) was introduced in Rel-16 and enhanced in Rel-17 as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells. In Rel-17, RAN4 specified RF and EMC requirements for such RF repeaters for NR targeting both FR1 and FR2.
While an RF repeater presents a cost effective means of extending network coverage, it has its limitations. An RF repeater simply does an amplify-and-forward operation without being able to take into account various factors that could improve performance. Such factors may include information on semi-static and/or dynamic downlink/uplink configuration, adaptive transmitter/receiver spatial beamforming, ON-OFF status, etc.
A smart repeater is an enhancement over conventional RF repeaters with the capability to receive and process side control information from the network. Side control information could allow a smart repeater to perform its amplify-and-forward operation in a more efficient manner. Potential benefits could include mitigation of unnecessary noise amplification, transmissions and receptions with better spatial directivity, and simplified network integration.”

It is thus desirable to improve the support of repeaters, and in particular, network-controlled repeaters which are expected to improve the radio coverage and efficiency of the network. For example, some network-controlled repeaters may be configured to use a repeater radio configuration such as an UL/DL configuration and/or beamforming configuration, which is may differ from that of the base station or gNB for improving the radio coverage and efficiency or reduce interference. However, such network-controlled repeaters are expected to receiving side control information which provide radio configuration information for the network-controlled repeater such that they are not expected to be supported by legacy base stations which do not have built-in support for such smart or network-controlled repeaters. This renders the efficient integration and use of a network-controlled repeater in a system comprising different versions of base stations difficult. Additionally, while a manual positioning and configuration of each repeater may be an option, this is not one that can be used in a large-scale network and which renders the configuration of equipment lengthy, difficult, more prone to errors and more difficult to maintain in the longer term. Another option might be to upgrade base stations to support network-controlled repeaters in advance to installing a network-controlled repeater, but this is not always achievable or practical and may require multiple engineers' visits to the site.

It is noted that some networks include IAB nodes which can operate as backhauling nodes to provide a backhaul link to the core network. However, an IAB node does not operate as a repeater and for example provide an interface for the terminal to connect to. Additionally, it is noteworthy that an IAB node can either connect to a base station that supports IAB functions or will not operate at all. While IAB nodes can provide an extension of coverage, they provide a different and complementary approach to that of network-controlled repeaters and in many cases network-controlled repeaters will be preferred and improving their support in current network is desirable.

Some systems also include relays which are directly connected to a base station (and which may not be chained like IAB nodes) however such relays are also directly connected to the terminal through a Uu interface. While the UE may not always be aware that it is connected to a relay (rather than a base station), the use of the relay is not transparent to the terminal as the terminal will be aware that it is connected to this node. This is in contrast to repeaters which are fully transparent to the terminal which is connected to the base station whose signal is repeated, not to the repeater.

While the configuration of a site that is to have a network-controlled repeater installed is an important challenge, an added difficulty with the configuration of network-controlled repeaters is the impacts they might have on neighbouring cells and how this impact can be managed.

### Smart Repeater Indicator

In examples of the present disclosure, a base station is configured to broadcast an indicator to notify receivers that the base station supports smart repeaters, also referred to as network-controlled repeaters. Such a network-controlled repeater indicator will also be referred herein as a smart repeater indicator in the present disclosure, in the interest of conciseness. It is noted that a legacy base station may not transmit any indicator at all whereas other base station may transmit such an indicator, at least when they can currently support network-controlled repeaters. In some cases, the base station may transmit an indicator that it does currently support network-controlled repeaters. The later indicator may for example be when the base station does not have any in-built support for this functionality or when the base station supports network-controlled repeaters but will not currently accept new network-controlled repeaters. In some cases, these two cases may be covered by the same indicator (e.g. in a case where the indicator is a one bit indicator which may be a first value when network-controlled repeaters are supported and the other value when they are not supported) and in other cases, they may be covered by different indicators. In the present disclosure, if a smart repeater indicator is discussed, unless it is specifically discussed as being a negative indicator, the indicator will be understood to mean an indicator indicating that network-controlled repeaters are supported (i.e. a positive indicator). In cases where the transmitted indicator is for communicating that the base station does not support network-controlled repeaters, it will be discussed as being a negative indicator.

The network-controlled repeater detecting such smart repeater indicator can connect to the base station (e.g. so that it can receive side control information from the base station) and can start operating in a network-controlled repeater mode. If the network-controlled repeater does not detect the indicator, it can search for another base station or cell (e.g. which provides such an indicator) or it can start operating in a basic, autonomous or non-smart repeater mode. For example, it can start operating in a passive mode or it can start operative in an active mode using configuration which is not provided by the base station or network. In the latter case, the regeneration of amplified signals may for example be based on configuration which is not configured using side control information.

In some cases, the network-controlled repeater will go through each detected candidate cell(s) and search for (monitor) the transmissions of the indicator the candidate cells until it finds a smart repeater indicator or until none of the candidate cells transmits a (positive) indicator. The network-controlled repeater may identify candidate cells based on a pre-configuration (e.g. if the network-controlled repeater has been configured to connected to one or more identified base stations), on a signal strength, another criterion and any combination thereof. Regarding the signal strength, the network-controlled repeater may select and/or prioritise base stations based on their respective signal strengths. A strong signal may indicate that the base station may not benefit from having its signal being amplified while a weak signal may benefit from amplification but it may difficult for the repeater to maintain a strong enough link with the base station for the communication of side control information. A relatively strong signal may also indicate that the repeater is in (relative) close proximity to the radio it is expected to amplify. This is because the repeater may be placed in a location where the closest radio node (in signal strength) is the one that the repeater is expected to amplify. The network-controlled repeater may thus be configured to monitor for the transmission of an indicator (and optionally for the transmission of a negative indicator or for the absence of an indicator) from candidate base stations where the candidate base stations are identified based on their respective signal strengths at the network-controlled repeater.

In some examples, the indicator may be broadcasted as part of the system information for a cell (sent by the corresponding base station or radio node) which supports network-controlled repeaters. For example, such a radio node may be a radio node which is configured to communicate with network-controlled repeaters to communicate side control information, for example which supports a physical (“PHY”) layer signalling for configuring the network-controlled repeaters. The system information transmission for transmitting a smart repeater indicator, for example a positive indicator or any one of a positive or negative indicator, may be a Master Information Block (MIB) transmission and/or a System Information Block (SIB) transmission.

Upon receiving this indicator, the network-controlled repeater can connect to this radio node, for example camp on this cell, and await the side control information for configuring and activating the network-controlled repeater operation mode of the repeater. Once the side control information (e.g. enhanced signalling and beam information) is received, the network-controlled repeater can configure the radio transmissions of the repeated signals based on the side control information and operate as a network-controlled repeater for the radio node. In some cases, the repeater may be operating as a regenerative repeater whereby it receives L1 signalling from the base station and can then create its own signalling towards UEs under its coverage. For example, the repeater may then regenerate the signalling from the radio node and retransmit it to the UEs and/or it may have its own signalling associated with beam configuration, for example for steering the beam in the direction of the UE. It is noteworthy that providing the indicator in MIB and/or SIB signalling is expected to provide a future-proof technique as it can be used with both regenerative and non-regenerative network-controlled repeaters.

In cases where the indicator is absent from the radio node's transmissions (e.g. if no indicator is transmitted at all or if the indicator is a negative indicator), and optionally if no other candidate cell with a positive indicator is identified, the network-controlled repeater can operate in an autonomous repeater mode, such as a passive mode or an active mode where the configuration is not based on control information received from a radio node.

According to techniques disclosed herein, an indicator signalling can be included, for example in the physical layer, to indicate if (or that) the base station supports network-controlled repeater operation. The signalling may be of one bit, two or more bits or signalled in combination with other parameters. The signalling may also be in system information such as MIB or SIB signalling, but also in DCI signalling. In such a DCI example, the network-controlled repeater can initially decode the MIB and the associated resource information (e.g. CORESET) and further receive DCI signalling from gNB without reading the SIB of the gNB. The DCI signalling may also include TDD UL-DL configuration (in particular in cases where the transmissions being repeated are TDD transmissions) and some power control parameters (e.g., maximum transmission power). In some examples, the DCI can be scrambled with a new RNTI to differentiate it from other DCIs carrying downlink control information for other UEs.

By using a DCI implementation, the network-controlled repeater may not need to implement upper layer protocol stacks and operations that would otherwise be required for the repeater to read the SIB and this can enable the repeater to have a less complex and costly implementation while still providing a smart repeating behaviour. Furthermore, smart receivers may also be configured to receive DCI transmissions using a dedicated narrow beam, that is using subset of the frequency resources compared to the frequency band used by the radio node and is not required to tune to or monitor system information (SIB) beams (which are can often be wider than dedicated beams). This can also reduce the power consumption of the repeater.

In some examples, a network-controlled repeater may obtain or attempt to obtain the side control information when in connected mode. For example, it may first camp on a cell. Optionally, it may then wait for side control information to be sent for example in SIB or DCI signalling. If not detected (or if not first awaiting the side control information from the base station), the network-controlled repeater can move to connected mode (e.g. to an RRC Connected state) and there is no new indication in system information in this case. During its transition to connected mode and once the security has been activated, the network-controlled repeater can be informed that the cell is capable of supporting the network-controlled repeater operation. This may be informed for example using DCI/MAC signalling, RRC signalling, other signalling and any combination thereof. Using this technique, a finer control can be achieved regarding which devices are allowed to operate in a network-controlled repeater mode. This may for example help reduce the risk of customers using their own devices as network-controlled repeaters with no or limited network oversight of such devices.

It will be appreciated that DCI/MAC signalling is not currently security protected. While the smart repeater indicator may be communicated using DCI/MAC signalling that is not security protected, it is also conceivable that DCI/MAC signalling may be security protected in the future and that the indicator will be sent through security-protected DCI/MAC signalling.

In some cases, the radio node may start sending the indicator once it has detected that a terminal (UE) can act as a network-controlled repeater and may thus be activated using the indicator. For example, a network-controlled repeater may report SR operation as a capability to the radio node. For example, the repeater may use procedures like some of the procedures currently implemented for UEs and, while acting as a UE, it can report this capability as a UE capability. UE capabilities are conventionally shared by a UE as part of the procedure for a UE's transition from IDLE to connected mode (in RRC). Based on this capability information received by the radio node and on the information received from core network regarding whether the device is allowed to operate as a network-controlled repeater or not (which may for example be based on subscriber information stored in the core network), the radio node can send the SR indicator to activate SR operation. This can for example be done using DCI/MAC signalling or RRC signalling. RRC signalling may for example be common (SIB) or dedicated (RRC message) signalling.

It will be appreciated that the techniques discussed herein are not limited to a transmission of the side control information in connected mode (e.g. RRC connected mode) but may also be used in other modes, such as in idle mode (RRC idle mode). Different types of signalling (e.g. DCI, SIB, etc.) may be used depending on whether the signalling is for terminals in connected or idle mode.

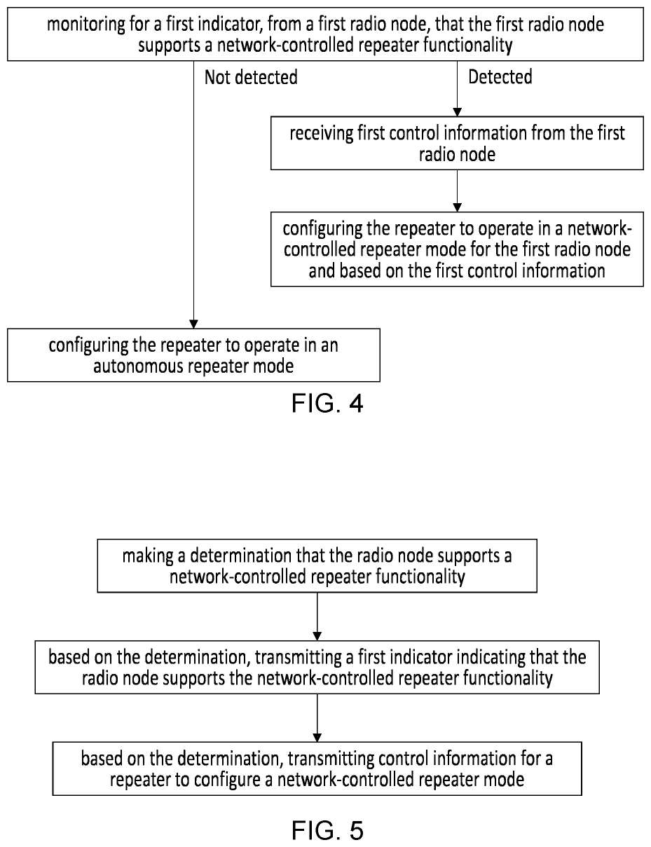

FIG. 4 illustrates an example method of operating a repeater in accordance with techniques discussed herein. The repeater first monitors a first indicator, from a first radio node, that the first radio node supports a network-controlled repeater functionality. If the indicator is detected, the repeater can then receive first control information from the first radio node and configure the repeater to operate in a network-controlled repeater mode for the first radio node and based on the first control information. On the other hand, if the indicator is not detected, the repeater can operate in an autonomous repeater mode, that is, in a non-network-controlled mode.

In some cases, configuring the repeater to operate in an autonomous repeater mode may comprise configuring the repeater to operate in an autonomous repeater mode for the first radio node. In other words, the repeater can use the configuration received from the first radio node to repeat signals from the first radio node, in a network-controlled or smart repeater mode.

Alternatively or additionally, in a network-controlled repeater mode, the repeater may operate as an active repeater wherein a radio configuration for the repeated transmissions is based on control information received from a radio node and/or in an autonomous repeater mode, the repeater operates as a passive repeater or as an active repeater configured without control information from a radio node, for example regardless or ignoring such control information. Said differently, in an autonomous repeater mode, the repeater operates as a receiver which is configured regardless of the radio node whose signals it is repeating.

In some implementations, the method may comprise monitoring for a second indicator from a second radio node of the telecommunications network that the second radio node supports the network-controlled repeater functionality. When the first indicator is not detected and when the second indicator is detected, the repeater may receive second control information from the second radio node; and configure the repeater to operate in a network-controlled repeater mode for the second radio node and based on the second control information. For example, the repeater may detect two radio nodes, only one of which is transmitting an indicator and the repeater may be configured to activate the network-controlled repeating for the radio node that is indicator that it supports this operation or mode.

Alternatively or additionally, the repeater may monitor for a second indicator from a second radio node of the telecommunications network that the second radio node supports the network-controlled repeater functionality. When the first indicator is not detected and when the second indicator is not detected, the repeater may be configured to operate in an autonomous repeater mode for one of the first radio node and second radio node. For example, if the repeater may detect two radio nodes, none of which is transmitting an indicator and the repeater may be then configured not to activate the network-controlled repeating and instead operate in an autonomous repeater mode.

In some implementations, the repeater may monitor for the first indicator by monitoring for the first indicator in a system information transmission from the first radio node or in a downlink control information (DCI) transmission from the first radio node. For example, system information transmission being monitored may be one or both of a Master Information Block (MIB) transmission and a System Information Block (SIB) transmission.

In cases where the first indicator is not detected and when the first radio node transmits a negative Intra Frequency Reselection Indicator (IFRI) for repeaters, the repeater being configured to operate in an autonomous repeater mode may comprise configuring the repeater to operate in an autonomous repeater mode for the first radio node. In cases where the first indicator is not detected and when the first radio node transmits a positive IFRI for repeaters, the repeater may be configured to monitor for a second indicator from a second radio node of the telecommunications network, the indicator indicating that the second radio node supports the network-controlled repeater functionality.

In some implementations, once configured in a network-controlled repeater mode for the first radio node, the repeater may measure an interference level at the repeater and send an interference report to the first radio node based on the measuring of the interference level. For example measuring the interference level may comprise measuring Sounding Reference Signal (SRS) resources and identifying an SRS identifier (SRS ID) associated with the SRS resources; and including the SRS ID in the indication of the interference report. In some examples, the repeater may be configured to receive, from the first radio node, a notification identifying a first terminal as being in the vicinity of the repeater where measuring an interference level at the repeater comprises measuring a signal strength from the first terminal.

In some examples, the repeater may be configured to receive a deactivation instruction, the deactivating instruction instructing the repeater to stop repeating signal; and in response to the deactivation instruction, exiting the network-controlled repeater mode and stopping the repeating of signals. Once the terminal stops repeating signals, it will no longer operate as a repeater, whether in a network-controlled or non-network controlled mode, in a passive or active mode, etc.

It will be appreciated that the first radio node may comprise one or more of: a base station, a gNodeB (gNB), a relay node, an IAB node and a terminal.

FIG. 5 illustrates an example method of operating a radio node in accordance with techniques discussed herein. The method comprises the radio making a determination that the radio node supports a network-controlled repeater functionality. Based on the determination (and optionally other criteria), the radio node can transmit a first indicator indicating that the radio node supports the network-controlled repeater functionality. Based on the determination (and optionally other criteria, e.g. based on a determination that a repeater is activating or has activated its network-controlled mode), it can transmit control information for a repeater to configure a network-controlled repeater mode.

In some cases, the radio node may also detect that the repeater is using the cell of the radio node, wherein the transmission of the control information for the repeater to configure the network-controlled repeater mode is in response to detecting that the repeater is using the cell.

In some implementations, the first indicator is transmitted in one or more of: a system information transmission; a Master Information Block (MIB) transmission; a System Information Block (SIB) transmission; a Radio Resource Control (RRC) transmission; an RRC transmission while the repeater in an RRC connected mode; and a downlink control information (DCI) transmission.

The radio node may also be configured to receive an interference report based on an interference level measured at the repeater; identify at least one terminal creating interference at the repeater; and take an interference remedial action in respect of the at least one terminal. For example, taking an interference remedial action can comprise updating a beam configuration for a beam to the at least one terminal. The at least one terminal may also be identified based on a Sounding Reference Signal (SRS) identifier (SRS ID) included in the interference report.

The radio node may be configured to send to the repeater a deactivation instruction, the deactivating instruction instructing the repeater to stop repeating signals. For example, the radio node may make a comparison of one or more first interference measurement reports associated with a time period prior to sending the deactivation instruction, while the repeater is in a network-controlled repeater mode, with one or more second interference measurement reports associated with a time period after the sending of the deactivation instruction, while the repeater has stopped repeating signals. Based on the comparison, the radio node can determine the impact of the network-controlled repeater on the level of interference and take an interference remedial action based on the determined impact. In some cases, where a deactivation instruction is sent, the radio node may be configured to receive an interference report based on an interference level measured at the repeater; wherein the sending of the deactivation instruction is in response to the interference report.

In some implementation, the radio node may be configured to identifying a first terminal in the vicinity of the repeater and to send to the repeater a notification of the first terminal being in the vicinity of the repeater. This may for example be used for the repeater to identify which resources to use for interference measurements.

According to techniques discussed herein, network-controlled repeaters may be included in a network which includes a combination of legacy radio nodes as well as radio nodes supporting a smart repeating operation and where the repeaters can still be used for amplifying in cases where smart repeating is not actually supported or where no such support has been detected. Further techniques are provided to further improve the operation of such a system.

According to techniques of the present invention, a network-controlled repeater may be added to a network using a “Plug and Play” techniques, for example, the following steps may be followed by the network-controlled repeater and overall system:
1. The network-controlled repeater is powered on and scans its surrounding environment.
2. The network-controlled repeater receives a smart repeater indicator from a radio node (from a cell).
3. The network-controlled repeater activates its network-controlled repeater mode in respect of the radio node.
4. The network-controlled repeater receives signalling (e.g. PHY signalling) communicating side control information.
5. The network-controlled repeater configures its (amplified) transmissions based on the side control information, for example by performing beam configuration and/or TDD configuration
6. The network-controlled repeater receives and amplifies signals from the radio node, using its network-controlled repeater configuration (see step 5).

In one example, the network-controlled repeater may be configured to monitor the best cells first (based on a predetermined metric or set of criteria, for example based on one or more of a signal strength, link quality, predetermined configuration or preferences, etc.). In some cases, the best cell selected by the network-controlled repeater does not support network-controlled repeater operation or Smart Repeater (SR) operation, for example if it does not have the ability to provide such support or it has the ability to do so but it is temporarily disabled due to congestion (e.g. disabled for all repeaters or for new additional repeaters). In such a case where the “best” cell (i.e. radio node) based on the repeater's selection metric does not support smart repeating for at least this repeater, the network-controlled repeater may select another cell or radio node (e.g. the second-best one if such a second best can be identified) based on the Intra Frequency Reselection Indicator (IFRI). It will be appreciated that while the network-controlled repeaters may re-use the IFRI broadcasted in some legacy systems (and used by terminals to decide if another cell on the same frequency could be a cell reselection candidate), in some cases it may be desirable to use a different IFRI for network-controlled repeaters as because the network or operator may allow network-controlled repeaters to camp on a second best cell while not allowing this behaviour for terminals.

Accordingly, in some implementations, this indicator may be different from such a legacy IFRI and/or the network-controlled repeater may ignore the IFRI bit in system information as currently defined in some telecommunications systems. For example, in a case where the best candidate cell does not support a smart repeating operation (whether because this is not implemented or not permitted, e.g. temporarily not allowed), the network-controlled repeater can ignore the IFRI setting transmitted for the benefit of terminals in that cell and search for or select the second best cell, even if the IFRI setting is configured to “not allowed”. In other words, the repeater may search for another cell or radio node regardless of what the IFRI bit is configured as. It will be noted that in a case where the radio node is for example a legacy radio node, it may not support any additional IFRI configuration as discussed herein and the network-controlled repeater would not receive any further bit or configuration in this respect.

On the other hand, if the network-controlled repeater implements some of the techniques discussed herein, it may receive one or more further settings from the base station. For example, it may receive an indication for network-controlled repeaters of whether the network-controlled repeaters can search for a second best cell if the best candidate cell does not support a network-controlled repeater operation (e.g. because it is not implemented in the base station or it is not currently allowed).

As the network-controlled repeater does not operate as a terminal, it can also be configured to ignore or disregard this and/or further configuration received from the base station. For example, the network-controlled repeater may be permitted to skip one or more access control checks and may for example ignore access control information broadcasted by the base station. For example, and with reference to section 7.4 of document TS 38.300 [4] (for example the last sentence), the repeater may disregard access control or unified access control information and procedures.

### Network-controlled Repeater Activation/Deactivation and Interference Management

The network-controlled repeater may be affected by interference from a nearby UE (“UE1”) transmitting on uplink resources where the same resource also used by a UE (“UE2”) served by network-controlled repeater for uplink transmission, as illustrated in FIG. 1. Such a situation would have a negative impact on the efficiency and reliability of the transmissions in the system.

Therefore, in some cases the network-controlled repeater is configured to inform the gNB about a level of interference. The gNB may be configured, in response to this, to allocate different resources for the UE1 and/or UE2 (which are also used by the repeater) and/or to change the configuration of one or more of its beams. For example, the gNB may stop or deviates its DL beam from the interfering UE UE1 and UE1 will assess its DL signal reception from gNB cell as poor. As a result, UE1 may then move into the coverage of the network-controlled repeater and be served by the network-controlled repeater.

In some implementations, the network-controlled repeater can measure an interference level from measurements of one or more UL Sounding Reference Signal (SRS) resources and send the measurement to gNB and the SRS ID. The gNB can then use the SRS ID to identify which UE has been configured to this SRS resource and thus identify the source of the interference. As discussed above, after identifying the UE, the gNB may take one or more appropriate actions for interference management. In some cases, the interference remedial action can include cross-link interference (CLI) mitigation. However, such techniques may imply that the network-controlled repeater may be expected to be aware of all UL SRS configurations in the cell from the gNB. This would however increase the complexity of the network-controlled repeater. With a view to reducing the complexity of the processing or implementation at the network-controlled repeater, the gNB may in some cases inform the network-controlled repeater of UEs close to the network-controlled repeater which is expected to reduce the complexity of the network-controlled repeater.

The gNB may identify one or more UEs located in close proximity to the network-controlled repeater by exploiting the direction and/or other beam configuration for the UEs and for the network-controlled repeater and at least one predefined criteria for determining which locations and/or directions are considered as close enough to be reported to the network-controlled repeater. Accordingly, the smart receiver can derive the SRS-RSRP of a given SRS resource ID and inform the gNB to handle the interference, if appropriate.

Whether the network-controlled repeater has received an identification of nearby UEs or not, the gNB may identify one or more nearby UEs to the network-controlled repeater using the SRS resource ID(s) from a measurement report received from the network-controlled repeater as the network-controlled repeater can report on measurements and on detected ID(s) from the detected SRS resource(s).

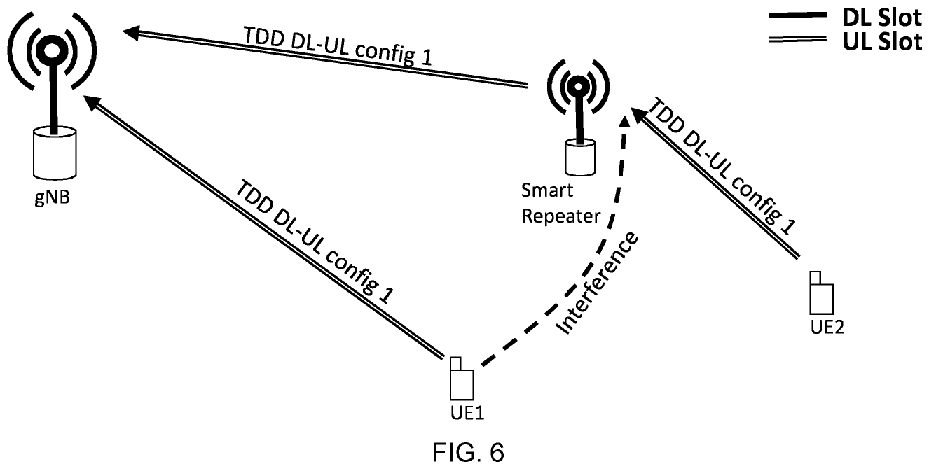

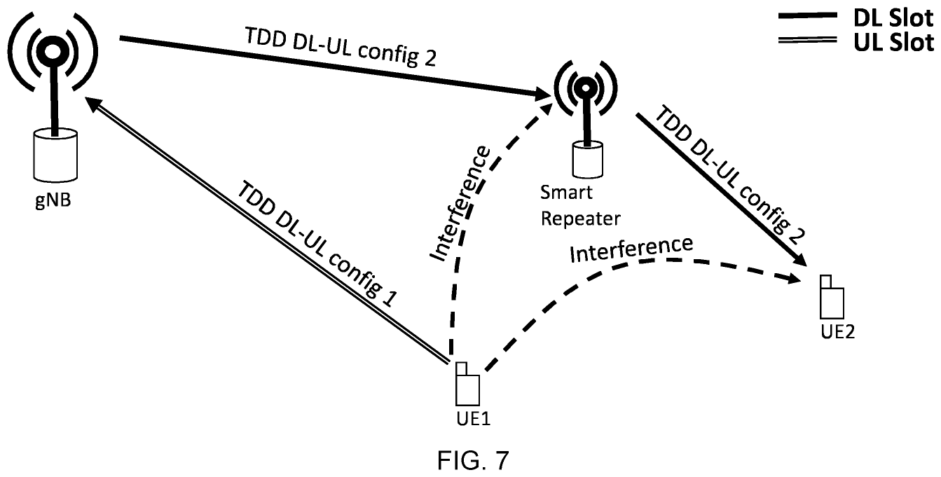

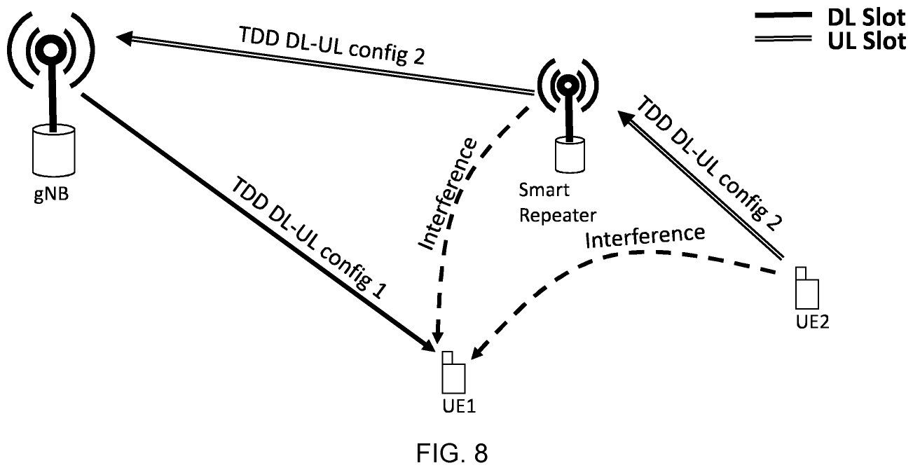

It should be noted that the network-controlled repeater and terminals in a cell for a radio node may use different TDD DL/UL patterns or configurations as shown on FIG. 7 and FIG. 8 such that the type of interference may be more varied than illustrated in FIG. 6. In FIG. 7 for example, UL transmissions from nearby UEs like UE1 can interfere on DL transmissions for the repeater in DL slots of the repeater. In other cases, and as illustrated in FIG. 8, UEs close to the network-controlled repeater (like UE 1) can have uplink transmissions from nearby UEs (repeated UEs or otherwise) and/or from the network-controlled repeater interfere with DL transmissions for the UE (e.g. UE1) on DL slots for the UE.

Accordingly, both the network-controlled repeater and UEs (e.g. UE1, UE2) may be configured to measure the interference from nearby nodes (e.g. UEs and/or repeaters). Such measurements may be done for example using Cross Link Interference “CLI” measurements. The UEs and/or network-controlled repeaters may then report on the measurements to the radio node for the cell. In some cases, the terminals and/or network-controlled repeater may be configured to report on the measured interference if the level of interference is above a threshold. More generally, it will be appreciated that such CLI measurements can be configured by the radio node and a UE and/or repeater may then carry out the configured measurements and report on these measurements.

For example, in the case of FIG. 7, both the network-controlled repeater and UE2 may measure the Reference Signal Received Power (RSRP) of the SRS (SRS-RSRP) of nearby UEs and report that UE1 is causing interference. It will be appreciated by the skilled person that other signal measurements may be used instead of or in combination with an RSRP measurement.

Likewise, in the case of FIG. 8, UEs close to the network-controlled repeater (like UE 1) may measure and report (e.g., CLI measurement) the interference from nearby terminals (repeated or not) and/or network-controlled repeaters. For example, UE1 may detect and report on interference caused by the network-controlled repeater and/or UE2. Again, any type of appropriate measurements may be used to measure and identify interference, typically RSRP measurements but Reference Signal Received Quality (RSRQ), Received Signal Strength Indicator (RSSI) or other types of measurements may be used as well, instead or in combination with RSRP.

According to techniques discussed herein, the base station may send an instruction to the network-controlled repeater to request that the repeater stops repeating transmissions (e.g. that the repeater exits the smart repeating mode and stops repeating or amplifying the transmissions). For example, a gNB may send the network-controlled repeater “suspend command”. This may be used for example to reduce interference and/or for measurement of uplink interference without the repeating and amplifying of signals by the repeater. It will be appreciated that when the repeater stops repeating signals, it does not operate in a network-controlled (or smart) mode nor does it operate in an autonomous mode.

In some cases, a network-controlled repeater may operate in FDD mode (and/or in a frequency band sometimes referred to as “FR1”). In that case, it is also susceptible to interference because the transmissions from UE(s) to the repeater and the forwarding from the repeater to the gNB can occur in the same frequency. Said differently, these two legs of the communication between the UE and the gNB can happen simultaneously in the same subframe. Accordingly, the gNB may receive the uplink signal from both the network-controlled repeater and from the UE which, depending on the beam configuration and/or radio conditions, may cause an unexpected and undesirable level of interference. For example, an uplink beam from UE may have one or more side lobes which may directly reach the gNB in addition to the relayed uplink signal from the network-controlled repeater. The interference impact of the repeater may be difficult to anticipate or predict. In some cases, and in particular in some FDD situations, the gNB may send the suspend command to temporarily stop the repeater and use the deactivation of the repeater to measure interference levels with and without the repeater being activated. The gNB can thus check the difference of level of (e.g. uplink in an FDD case) interference when network-controlled repeater is activated and deactivated. The command or instruction may be sent for example using a signature pattern, using a technique similar to one used for sending commands like wake-up signals.

In some cases, the suspend command may not be associated with a duration and the repeater may remain deactivated until it is reactivated (e.g. with a command or manually) and/or until it is restarted, etc. In other cases, e.g. if the deactivation is used to make interference measurements, the repeater may stop repeating transmissions for a time which is pre-defined or pre-configured, which is configured at least partially via signalling (with the command or prior to the command), etc.

It will be appreciated that while the present techniques are expected to be particular helpful in a TDD environment, they are not limited to a TDD system and, as discussed above, are equally applicable to FDD environment, mixed environment or any other type of system of allocating time and frequency resources to UL and DL transmissions. For example, a network-controlled repeater may be having transmissions from a nearby UE on uplink resources create interference where the same resource also used by a UE under the network-controlled repeater for its uplink transmissions.

While in many cases discussed above, the amplified signal received at the smart amplifier is expected to be that of a gNB or base station, it will be appreciated that the same principle applies to other types of radio nodes. Other radio nodes can for example include IAB nodes, relays, etc. which can provide a wireless interface to terminals and through which side control information may be transmitted to the network-controlled repeater for configuring the transmissions of the repeater. It is also conceivable that the radio node may be a radio node, which can transmit the side control information via a PC5 interface. Even though the main use cases for the techniques discussed herein are likely to be for radio nodes such as base stations, IAB nodes, relay nodes, etc. which communicate with the repeater via a Uu interface, the principles and techniques discussed herein are equally applicable to a radio node communicating with the repeater via another interface, such as a terminal communicating with the repeater via a sidelink or PC5 interface.

While reference has sometimes been made to particular sets of standards, for example different release versions (“Release 17”, etc.), it will be appreciated that this is done for illustrative purposes only and the teachings and techniques of the present invention are not limited to these particular systems but rather these systems are used to illustrate which limitations that can be found in some systems and why.

Additionally, the method steps discussed in the present description may be carried out in any suitable order as long as it is technically feasible and the illustrated order is not prescriptive. For example, steps may be carried out in an order which differs from an order used in the examples discussed above or from an indicative order used anywhere else for listing steps (e.g. in the claims), whenever possible or appropriate. Thus, in some cases, some steps may be carried out in a different order, or simultaneously or in the same order. So long as an order for carrying any of the steps of any method discussed herein is technically feasible, it is explicitly encompassed within the present disclosure.

As used herein, transmitting information or a message to an element may involve sending one or more messages to the element and may involve sending part of the information separately from the rest of the information. The number of “messages” involved may also vary depending on the layer or granularity considered. For example, transmitting a message may involve using several resource elements in an LTE or NR environment such that several signals at a lower layer correspond to a single message at a higher layer. In addition, transmissions from one node to another may relate to the transmission of any one or more of user data, system information, control signalling and any other type of information to be transmitted.

In addition, whenever an aspect is disclosed in respect of an apparatus or system, the teachings are also disclosed for the corresponding method and for the corresponding computer program. Likewise, whenever an aspect is disclosed in respect of a method, the teachings are also disclosed for any suitable corresponding apparatus or system. Additionally, it is also hereby explicitly disclosed that for any teachings relating to a method or a system where it has not been clearly specified which element or elements are configured to carry out a function or a step, any suitable element or elements that can carry out the function can be configured to carry out this function or step. For example, any one or more of a terminal device or network node may be configured accordingly if appropriate, so long as it is technically feasible and not explicitly excluded.

Whenever the expressions “greater than” or “smaller than” or equivalent are used herein, it is intended that they disclose both alternatives “and equal to” and “and not equal to” unless one alternative is expressly excluded.

It will be appreciated that while the present disclosure has in some respects focused on implementations in a 4G or 5G network as such a network is expected to provide the primary use case at present, the same teachings and principles can also be applied to other wireless telecommunications systems. Thus, even though the terminology used herein is generally the same or similar to that of the 4G or 5G standards, the teachings are not limited to the present versions of 4G or 5G and could apply equally to any appropriate arrangement not based on 4G or 5G, for example any arrangement possibly compliant with any future version of an LTE, 5G or other standards—defined by the 3GPP standardisation groups or by other groups. Accordingly, the teaching provided herein using 3GPP, 4G and/or 5G terminology can be equally applied to other systems with reference to the corresponding functions.

It is noteworthy that where a “predetermined” element is mentioned, it will be appreciated that this can in some cases include a configurable element, wherein the configuration can be done by any combination of a manual configuration by a user or administrator or a transmitted communication, for example from the network or from a service provider (e.g. a device manufacturer, an OS provider, etc.).

Techniques discussed herein can be implemented using a computer program product or computer readable medium, comprising for example computer-readable instructions which can be executed by a computer, for carrying a method according to the present disclosure. Such a computer readable medium may be a non-transitory computer-readable storage medium with an executable program stored thereon, wherein the program instructs a microprocessor to perform said method. Additionally, or alternatively, the techniques discussed herein may be realised at least in part by a computer readable communication medium that carries or communicates code in the form of instructions or data structures and that can be accessed, read, and/or executed by a computer.

In other words, any suitable computer readable medium may be used, which comprises instructions and which can for example be a transitory medium, such as a communication medium, or a non-transitory medium, such as a storage medium. Accordingly, a computer program product may be a non-transitory computer program product.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely illustrative examples of the present disclosure. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered clauses:

Clause 1. A method of operating a repeater in a telecommunications network, the telecommunications network comprising at least a first radio node and a terminal wherein the first radio node is configured to provide a wireless access interface to communicate with the terminal, the method comprising:
monitoring for a first indicator, from the first radio node, that the first radio node supports a network-controlled repeater functionality;
when the first indicator is detected:
receiving first control information from the first radio node; and configuring the repeater to operate in a network-controlled repeater mode for the first radio node and based on the first control information; and
when the first indicator is not detected, configuring the repeater to operate in an autonomous repeater mode.
Clause 2. The method of Clause 1 wherein configuring the repeater to operate in an autonomous repeater mode comprises configuring the repeater to operate in an autonomous repeater mode for the first radio node.
Clause 3. The method of Clause 1 or 2 wherein,
in a network-controlled repeater mode, the repeater operates as an active repeater wherein a radio configuration for the repeated transmissions is based on control information received from a radio node and in an autonomous repeater mode, the repeater operates as a passive repeater or as an active repeater configured without control information from a radio node.
Clause 4. The method of any preceding Clause further comprising:
monitoring for a second indicator from a second radio node of the telecommunications network that the second radio node supports the network-controlled repeater functionality; and
when the first indicator is not detected and when the second indicator is detected: receiving second control information from the second radio node; and
configuring the repeater to operate in a network-controlled repeater mode for the second radio node and based on the second control information.
Clause 5. The method of any preceding Clause further comprising:
monitoring for a second indicator from a second radio node of the telecommunications network that the second radio node supports the network-controlled repeater functionality; and
when the first indicator is not detected and when the second indicator is not detected:
configuring the repeater to operate in an autonomous repeater mode for one of the first radio node and second radio node.
Clause 6. The method of any preceding Clause wherein monitoring for the first indicator comprises monitoring for the first indicator in a system information transmission from the first radio node or in a downlink control information (DCI) transmission from the first radio node.
Clause 7. The method of Clause 6 wherein the monitored system information transmission is at least one of a Master Information Block (MIB) transmission and a System Information Block (SIB) transmission.
Clause 8. The method of any preceding Clause wherein when the first indicator is not detected and
when the first radio node transmits a negative Intra Frequency Reselection Indicator (IFRI) for repeaters, configuring the repeater to operate in an autonomous repeater mode comprises configuring the repeater to operate in an autonomous repeater mode for the first radio node; and
when the first radio node transmits a positive IFRI for repeaters, monitoring for a second indicator from a second radio node of the telecommunications network that the second radio node supports the network-controlled repeater functionality.
Clause 9. The method of any preceding Clause, further comprising, once configured in a network-controlled repeater mode for the first radio node:
measuring an interference level at the repeater;

sending an interference report to the first radio node based on the measuring of the interference level.

Clause 10. The method of Clause 9 wherein measuring the interference level comprises: measuring Sounding Reference Signal (SRS) resources and identifying an SRS identifier (SRS ID) associated with the SRS resources; and
including the SRS ID in the indication of the interference report.
Clause 11. The method of Clause 9 or 10 further comprising:
receiving, from the first radio node, a notification identifying a first terminal as being in the vicinity of the repeater;
wherein measuring an interference level at the repeater comprises measuring a signal strength from the first terminal.
Clause 12. The method of any preceding Clause further comprising:
receiving a deactivation instruction, the deactivating instruction instructing the repeater to stop repeating signal; and
in response to the deactivation instruction, exiting the network-controlled repeater mode and stopping the repeating of signals.
Clause 13. The method of any preceding Clause wherein the first radio node is at least one of a base station, a gNodeB (gNB), a relay node, an IAB node and a terminal.
Clause 14. A repeater for use in a telecommunications network, the telecommunications network comprising at least a first radio node and a terminal wherein the first radio node is configured to provide a wireless access interface to communicate with the terminal, the repeater being configured to:
monitor for a first indicator, from the first radio node, that the first radio node supports a network-controlled repeater functionality; when the first indicator is detected:
receive first control information from the first radio node; and
configure the repeater to operate in a network-controlled repeater mode for the first radio node and based on the first control information; and
when the first indicator is not detected, configure the repeater to operate in an autonomous repeater mode.
Clause 15. The repeater of Clause 14 wherein the repeater being configured to configure Clause 15. the repeater to operate in an autonomous repeater mode comprises the repeater being configured to configure the repeater to operate in an autonomous repeater mode for the first radio node.
Clause 16. The repeater of Clause 14 or 15 wherein the repeater is configured to:
in a network-controlled repeater mode, operate as an active repeater wherein a radio configuration for the repeated transmissions is based on control information received from a radio node and
in an autonomous repeater mode, operate as a passive repeater or as an active repeater configured without control information from a radio node.
Clause 17. The repeater of any one of Clauses 14 to 16 further comprising the repeater being configured to:
monitor for a second indicator from a second radio node of the telecommunications network that the second radio node supports the network-controlled repeater functionality; and
when the first indicator is not detected and when the second indicator is detected:
receive second control information from the second radio node; and
configure the repeater to operate in a network-controlled repeater mode for the second radio node and based on the second control information.
Clause 18. The repeater of one of Clauses 14 to 17 further comprising the repeater being configured to:
monitor for a second indicator from a second radio node of the telecommunications network that the second radio node supports the network-controlled repeater functionality; and when the first indicator is not detected and when the second indicator is not detected: configure the repeater to operate in an autonomous repeater mode for one of the first radio node and second radio node.
Clause 19. The repeater of one of Clauses 14 to 18 wherein the repeater being configured to monitor for the first indicator comprises the repeater being configured to monitor for the first indicator in a system information transmission from the first radio node or in a downlink control information (DCI) transmission from the first radio node.
Clause 20. The repeater of Clause 19 wherein the monitored system information transmission is at least one of a Master Information Block (MIB) transmission and a System Information Block (SIB) transmission.
Clause 21. The repeater of one of Clauses 14 to 20 wherein the repeater being configured to, when the first indicator is not detected and
when the first radio node transmits a negative Intra Frequency Reselection Indicator (IFRI) for repeaters, configure the repeater to operate in an autonomous repeater mode comprises configuring the repeater to operate in an autonomous repeater mode for the first radio node; and
when the first radio node transmits a positive IFRI for repeaters, monitor for a second indicator from a second radio node of the telecommunications network that the second radio node supports the network-controlled repeater functionality.
Clause 22. The repeater of one of Clauses 14 to 21, further comprising the repeater being configured to, once configured in a network-controlled repeater mode for the first radio node: measure an interference level at the repeater;

send an interference report to the first radio node based on the measuring of the interference level.

Clause 23. The repeater of Clause 22 wherein the repeater being configured to measure the interference level comprises the repeater being configured to: measure Sounding Reference Signal (SRS) resources and identifying an SRS identifier (SRS ID) associated with the SRS resources; and
include the SRS ID in the indication of the interference report.
Clause 24. The repeater of Clause 22 or 23 further comprising the repeater being configured to:
receive, from the first radio node, a notification identifying a first terminal as being in the vicinity of the repeater;
wherein the repeater being configured to measure an interference level at the repeater comprises the repeater being configured to measure a signal strength from the first terminal.
Clause 25. The repeater of one of Clauses 14 to 24 further comprising the repeater being configured to:
receive a deactivation instruction, the deactivating instruction instructing the repeater to stop repeating signal; and
in response to the deactivation instruction, exit the network-controlled repeater mode and stopping the repeating of signals.
Clause 26. The repeater of one of Clauses 14 to 25 wherein the first radio node is at least one of a base station, a gNodeB (gNB), a relay node, an IAB node and a terminal.
Clause 27. A repeater for use in a telecommunications network, the repeater being configured to implement the method of any one of Clauses 1 to 13.
Clause 28. Circuitry for a repeater for use in a telecommunications network, the telecommunications network comprising a first radio node and a terminal wherein the first radio node is configured to provide a wireless access interface to communicate with the terminal, wherein the circuitry comprises a controller element and a transceiver element configured to operate together to
monitor for a first indicator, from the first radio node, that the first radio node supports a network-controlled repeater functionality;
when the first indicator is detected:
receive first control information from the first radio node; and
configure the repeater to operate in a network-controlled repeater mode for the first radio node and based on the first control information; and
when the first indicator is not detected, configure the repeater to operate in an autonomous repeater mode.
Clause 29. Circuitry for a repeater for use in a telecommunications network, the telecommunications network comprising a first radio node and a terminal wherein the first radio node is configured to provide a wireless access interface to communicate with the terminal, wherein the circuitry comprises a controller element and a transceiver element configured to operate together to implement the method of any one of Clauses 1 to 13.
Clause 30. A method of operating a radio node in a telecommunications network, the telecommunications network comprising at least the radio node, a repeater and a terminal wherein the radio node is configured to provide a wireless access interface to communicate with the terminal and wherein the repeater is configured to amplify signals from the radio node and to the terminal, the method comprising:
making a determination that the radio node supports a network-controlled repeater functionality;
based on the determination, transmitting a first indicator indicating that the radio node supports the network-controlled repeater functionality; and
based on the determination, transmitting control information for the repeater to configure a network-controlled repeater mode.
Clause 31. The method of Clause 30, further comprising detecting that the repeater is using the cell of the radio node, wherein the transmission of the control information for the repeater to configure the network-controlled repeater mode is in response to detecting that the repeater is using the cell.
Clause 32. The method of Clause 30 or 31, wherein the first indicator is transmitted in one or more of
a system information transmission;
a Master Information Block (MIB) transmission;
a System Information Block (SIB) transmission;
a Radio Resource Control (RRC) transmission;
an RRC transmission while the repeater in an RRC connected mode; and
a downlink control information (DCI) transmission.
Clause 33. The method of any one of Clauses 30 to 32, further comprising
receiving an interference report based on an interference level measured at the repeater;
identifying at least one terminal creating interference at the repeater; and
taking an interference remedial action in respect of the at least one terminal.
Clause 34. The method of Clause 33 wherein taking an interference remedial action comprises updating a beam configuration for a beam to the at least one terminal.
Clause 35. The method of Clause 33 or 34 wherein the at least one terminal is identified based on a Sounding Reference Signal (SRS) identifier (SRS ID) included in the interference report.
Clause 36. The method of any one of Clauses 30 to 35 further comprising
sending to the repeater a deactivation instruction, the deactivating instruction instructing the repeater to stop repeating signals.
Clause 37. The method of Clause 36 further comprising
making a comparison of one or more first interference measurement reports associated with a time period prior to sending the deactivation instruction, while the repeater is in a network-controlled repeater mode, with one or more second interference measurement reports associated with a time period after the sending of the deactivation instruction, while the repeater has stopped repeating signals;
based on the comparison, determining the impact of the network-controlled repeater on the level of interference;
taking an interference remedial action based on the determined impact.
Clause 38. The method of Clause 36 or 37 further comprising
receiving an interference report based on an interference level measured at the repeater; and
wherein the sending of the deactivation instruction is in response to the interference report.
Clause 39. The method of any one of Clauses 30 to 38 further comprising:
identifying a first terminal in the vicinity of the repeater;
sending to the repeater a notification of the first terminal being in the vicinity of the repeater.
Clause 40. The method of anyone of Clauses 30 to 39 wherein the radio node is at least one of a base station, a gNodeB (gNB), a relay node, an IAB node and a terminal.
Clause 41. A radio node for use in a telecommunications network, the telecommunications network comprising at least the radio node, a repeater and a terminal wherein the radio node is configured to provide a wireless access interface to communicate with the terminal and wherein the repeater is configured to amplify signals from the radio node and to the terminal, the radio node being configured to:
make a determination that the radio node supports a network-controlled repeater functionality; based on the determination, transmit a first indicator indicating that the radio node supports the network-controlled repeater functionality; and based on the determination, transmit control information for the repeater to configure a network-controlled repeater mode.
Clause 42. The radio node of Clause 41, further comprising detecting that the repeater is using the cell of the radio node, wherein the transmission of the control information for the repeater to configure the network-controlled repeater mode is in response to detecting that the repeater is using the cell.
Clause 43. The radio node of Clause 41 or 42, wherein the first indicator is transmitted in Clause 43.
one or more of
a system information transmission;
a Master Information Block (MIB) transmission;
a System Information Block (SIB) transmission;
a Radio Resource Control (RRC) transmission;
an RRC transmission while the repeater in an RRC connected mode; and
a downlink control information (DCI) transmission.
Clause 44. The radio node of any one of Clauses 41 to 43, further comprising
receiving an interference report based on an interference level measured at the repeater;
identifying at least one terminal creating interference at the repeater; and
taking an interference remedial action in respect of the at least one terminal.
Clause 45. The radio node of Clause 44 wherein taking an interference remedial action comprises updating a beam configuration for a beam to the at least one terminal.
Clause 46. The radio node of Clause 44 or 45 wherein the at least one terminal is identified based on a Sounding Reference Signal (SRS) identifier (SRS ID) included in the interference report.
Clause 47. The radio node of any one of Clauses 41 to 46 further comprising
sending to the repeater a deactivation instruction, the deactivating instruction instructing the repeater to stop repeating signals.
Clause 48. The radio node of Clause 47 further comprising
making a comparison of one or more first interference measurement reports associated with a time period prior to sending the deactivation instruction, while the repeater is in a network-controlled repeater mode, with one or more second interference measurement reports associated with a time period after the sending of the deactivation instruction, while the repeater has stopped repeating signals;
based on the comparison, determining the impact of the network-controlled repeater on the level of interference;
taking an interference remedial action based on the determined impact.

Clause 49. The radio node of Clause 47 or 48 further comprising

receiving an interference report based on an interference level measured at the repeater; and
wherein the sending of the deactivation instruction is in response to the interference report.
Clause 50. The radio node of any one of Clauses 41 to 49 further comprising:
identifying a first terminal in the vicinity of the repeater;
sending to the repeater a notification of the first terminal being in the vicinity of the repeater.
Clause 51. The radio node of anyone of Clauses 41 to 50 wherein the radio node comprises at least one of a base station, a gNodeB (gNB), a relay node, an IAB node and a terminal.
Clause 52. A radio node for use in a telecommunications network, the telecommunications network comprising the radio node, a repeater and a terminal wherein the radio node is configured to provide a wireless access interface to communicate with the terminal and wherein the repeater is configured to amplify signals from the radio node and to the terminal, the radio node being configured to implement the method of any one of Clauses 30 to 40.
Clause 53. Circuitry for a radio node for use in a telecommunications network, the telecommunications network comprising the radio node, a repeater and a terminal wherein the radio node is configured to provide a wireless access interface to communicate with the terminal and wherein the repeater is configured to amplify signals from the radio node and to the terminal, wherein the circuitry comprises a controller element and a transceiver element configured to operate together to make a determination that the radio node supports a network-controlled repeater functionality; based on the determination, transmit a first indicator indicating that the radio node supports the network-controlled repeater functionality; and
based on the determination, transmit control information for the repeater to configure a network-controlled repeater mode.
Clause 54. Circuitry for a radio node for use in a telecommunications network, the telecommunications network comprising the radio node, a repeater and a terminal wherein the radio node is configured to provide a wireless access interface to communicate with the terminal and wherein the repeater is configured to amplify signals from the radio node and to the terminal, wherein the circuitry comprises a controller element and a transceiver element configured to operate together to implement the method of any one of Clauses 30 to 40.
Clause 55. A method of operating a system in a telecommunications network, the system comprising a repeater, a first radio node and a terminal wherein the first radio node is configured to provide a wireless access interface to communicate with the terminal, the method comprising:
the first radio node making a determination that the radio node supports a network-controlled repeater functionality;
the first radio node, based on the determination, transmitting a first indicator indicating that the radio node supports the network-controlled repeater functionality;
the repeater monitoring for the first indicator;
the first radio node, based on the determination, transmitting control information for the repeater to configure a network-controlled repeater mode.
the repeater, when the first indicator is detected:
receiving first control information from the first radio node; and
configuring the repeater to operate in a network-controlled repeater mode for the first radio node and based on the first control information; and
when the first indicator is not detected, configuring the repeater to operate in an autonomous repeater mode.
Clause 56. A method of operating a system in a telecommunications network, the system comprising a repeater, a first radio node and a terminal wherein the first radio node is configured to provide a wireless access interface to communicate with the terminal, the method comprising:
operating the repeater in accordance with the method of any one of Clauses 1 to 13; and
operating the radio node in accordance with the method of any one of Clauses 30 to 40.
Clause 57. A system for use in a telecommunications network, the system comprising a Clause 57. repeater, a first radio node and a terminal wherein the first radio node is configured to provide a wireless access interface to communicate with the terminal, wherein:
the first radio node is configured to:
make a determination that the radio node supports a network-controlled repeater functionality; based on the determination, transmit a first indicator indicating that the radio node supports the network-controlled repeater functionality;
based on the determination, transmit control information for the repeater to configure a network-controlled repeater mode
the repeater is configured to:
monitor for the first indicator;
when the first indicator is detected:
receive first control information from the first radio node; and
configure the repeater to operate in a network-controlled repeater mode for the first radio node and based on the first control information; and
when the first indicator is not detected, configure the repeater to operate in an autonomous repeater mode.
Clause 58. A system for use in a telecommunications network, the system comprising a repeater, a first radio node and a terminal wherein the first radio node is configured to provide a wireless access interface to communicate with the terminal,
wherein the repeater is configured in accordance with any one of Clauses 14 to 26; and wherein the first radio node is configured in accordance with any one of Clauses 41 to 51.

### REFERENCES

[1] Holma H. and Toskala A, “LTE for UMTS OFDMA and SC-FDMA based radio access”, John Wiley and Sons, 2009.
[2] 3GPP document RP-212703 “Study on NR Smart Repeaters” (TSG RAN Meeting #94e, Dec. 6-17, 2021)
[3] 3GPP document RP-213700 “Study on NR Network-controlled Repeaters” (TSG RAN Meeting #94e, Dec. 6-17, 2021)
[4] 3GOO document TS 38.300 “NR; NR and NG-RAN Overall description; Stage-2” (V16.8.0, December 2021)

1. A method of operating a repeater in a telecommunications network, the telecommunications network comprising at least a first radio node and a terminal wherein the first radio node is configured to provide a wireless access interface to communicate with the terminal, the method comprising:
monitoring for a first indicator, from the first radio node, that the first radio node supports a network-controlled repeater functionality;
when the first indicator is detected:
receiving first control information from the first radio node; and
configuring the repeater to operate in a network-controlled repeater mode for the first radio node and based on the first control information; and
when the first indicator is not detected, configuring the repeater to operate in an autonomous repeater mode.

2. The method of claim 1 wherein configuring the repeater to operate in an autonomous repeater mode comprises configuring the repeater to operate in an autonomous repeater mode for the first radio node.

3. The method of claim 1 wherein,
in a network-controlled repeater mode, the repeater operates as an active repeater wherein a radio configuration for the repeated transmissions is based on control information received from a radio node and
in an autonomous repeater mode, the repeater operates as a passive repeater or as an active repeater configured without control information from a radio node.

4. The method of claim 1 further comprising:
monitoring for a second indicator from a second radio node of the telecommunications network that the second radio node supports the network-controlled repeater functionality; and
when the first indicator is not detected and when the second indicator is detected:
receiving second control information from the second radio node; and
configuring the repeater to operate in a network-controlled repeater mode for the second radio node and based on the second control information.

5. The method of claim 1 further comprising:
monitoring for a second indicator from a second radio node of the telecommunications network that the second radio node supports the network-controlled repeater functionality; and
when the first indicator is not detected and when the second indicator is not detected:
configuring the repeater to operate in an autonomous repeater mode for one of the first radio node and second radio node.

6. The method of claim 1 wherein monitoring for the first indicator comprises monitoring for the first indicator in a system information transmission from the first radio node or in a downlink control information (DCI) transmission from the first radio node.

7. The method of claim 6 wherein the monitored system information transmission is at least one of a Master Information Block (MIB) transmission and a System Information Block (SIB) transmission.

8. The method of any preceding claim 1 wherein when the first indicator is not detected and
when the first radio node transmits a negative Intra Frequency Reselection Indicator (IFRI) for repeaters, configuring the repeater to operate in an autonomous repeater mode comprises configuring the repeater to operate in an autonomous repeater mode for the first radio node; and
when the first radio node transmits a positive IFRI for repeaters, monitoring for a second indicator from a second radio node of the telecommunications network that the second radio node supports the network-controlled repeater functionality.

9. The method of claim 1, further comprising, once configured in a network-controlled repeater mode for the first radio node:
measuring an interference level at the repeater;
sending an interference report to the first radio node based on the measuring of the interference level.

10. The method of claim 9 wherein measuring the interference level comprises:
measuring Sounding Reference Signal (SRS) resources and identifying an SRS identifier (SRS ID) associated with the SRS resources; and
including the SRS ID in the indication of the interference report.

11. The method of claim 9 further comprising:
receiving, from the first radio node, a notification identifying a first terminal as being in the vicinity of the repeater;
wherein measuring an interference level at the repeater comprises measuring a signal strength from the first terminal.

12. The method of claim 1 further comprising:
receiving a deactivation instruction, the deactivating instruction instructing the repeater to stop repeating signal; and
in response to the deactivation instruction, exiting the network-controlled repeater mode and stopping the repeating of signals.

13. The method of claim 1 wherein the first radio node is at least one of a base station, a gNodeB (gNB), a relay node, an IAB node and a terminal.

14. A repeater for use in a telecommunications network, the telecommunications network comprising at least a first radio node and a terminal wherein the first radio node is configured to provide a wireless access interface to communicate with the terminal, the repeater being configured to:
monitor for a first indicator, from the first radio node, that the first radio node supports a network-controlled repeater functionality;
when the first indicator is detected:
receive first control information from the first radio node; and
configure the repeater to operate in a network-controlled repeater mode for the first radio node and based on the first control information; and
when the first indicator is not detected, configure the repeater to operate in an autonomous repeater mode.

15-26. (canceled)

27. A radio node for use in a telecommunications network, the telecommunications network comprising at least the radio node, a repeater and a terminal wherein the radio node is configured to provide a wireless access interface to communicate with the terminal and wherein the repeater is configured to amplify signals from the radio node and to the terminal, the radio node being configured to:
make a determination that the radio node supports a network-controlled repeater functionality;
based on the determination, transmit a first indicator indicating that the radio node supports the network-controlled repeater functionality; and
based on the determination, transmit control information for the repeater to configure a network-controlled repeater mode.

28-30. (canceled)
